(19) United States
(12) Patent Application Publication
(10) Pub. No.: US 2008/0234611 A1
(43) Pub. Date: Sep. 25, 2008

(54) Massaging Device

(75) Inventors: Hiroei Sakai, Niigata (JP); Kazuyuki Takeda, Niigata (JP)

Correspondence Address: AKERMAN SENTERFITT, P.O. BOX 3188, WEST PALM BEACH, FL, 33402-3188, US

(73) Assignee: Twinbird Corporation, Tsubame-shi (JP)

(21) Appl. No.: 11/966,354

(22) Filed: Dec. 28, 2007

(30) Foreign Application Priority Data
Mar. 19, 2007 (JP) 2007-071444

(51) Int. Cl. A61H 7/00

(52) U.S. Cl. 601/95; 601/137; 601/136

(57) ABSTRACT

A massaging device enabling hair wash and massage of a scalp to be readily performed effectively and reliably. The massaging device 1 includes a massaging device main body 2 acting as a drive section and a treating section 3. The treating section 3 includes a base portion 4 made of a flexible material and a plurality of first protrusions 5 protruding in a downward direction that is the direction of intersecting with a surface of the base portion 4. The massaging device main body 2 includes a reciprocating drive means 12. A reciprocating drive means 12 is provided to allow the base portion 4 to defect in an up-and-down direction that intersects with a surface of the base portion 4. Each of the first protrusions 5 includes a communicating slit 25 which allows an interior and an exterior to communicate with each other. A container 26 for a shampoo L is provided inside the base portion 4. The container 26 communicates with the communicating slit 25, and moves in response to the deflection of the base portion 4. As a result, the shampoo L infiltrated into the container 26 is foamed in response to the deflection of the base portion 4 to permit hair washing and massaging to be performed with said shampoo L being supplied from the communicating slit 25.

### FIELD OF THE INVENTION

The present invention relates to a power-driven massaging device, particularly to a massaging device used for massaging a scalp, washing the scalp by rubbing it or for other applications in washing hair or the like.

### BACKGROUND OF THE INVENTION

Conventionally, as this kind of the massaging device, dual-purpose brushes for massaging and washing electrically are known, for example, in Japanese un-examined patent publication No. 2001-258974. In the brushes, a vibratory head is attached via an elastic member to a casing containing a motor, and a motor shaft of the motor is protruded in the vibratory head, and an oscillator is eccentrically attached to the motor shaft. And further a brush section made of a flexible material is attached to a surface of the vibratory head. The dual-purpose brush comprises a brush body section serving as a base portion formed in a disk-shape and needle-like pieces serving as a number of projections protruded from a surface of the brush body section. When this dual-purpose brush is used, a user, first, holds the casing to place the brush section over his/her scalp and then activates a motor. As a result, vibration caused by the eccentric rotation of the oscillator built in the vibratory head, is transferred to the scalp via the vibratory head and the brush section. The brush section is made of such a flexible material that debris and sebum in the pores are removed without injuring the scalp while a massage is performed.

According to these conventional massaging devices, for example when scalp massage is performed at hair wash, the vibration caused by the eccentric rotation of the oscillator built in the vibratory head, is transferred to the scalp via the vibratory head and the brush section made of the flexible material. The brush section, however, simply vibrates against the scalp, so that massage cannot be sufficiently performed on the scalp etc. and the debris of the scalp cannot be sufficiently removed, either.

As a device for solving the foregoing problems, applicant of the present invention once proposed a certain massaging device in Japanese patent application No. 2006-53738. This device includes a drive section including a frame; a treating section operated by said drive section, said treating section including: a base portion made of an flexible material, said base portion being detachably retained by said frame of the drive section with a periphery thereof being held in a fixed position relative to said drive section; and a plurality of projections protruded from said base portion; and a reciprocating drive means provided in said drive section for deflecting said base portion in a direction intersecting with a surface of said base portion.

When massaging, the base portion of the treating section is allowed to deflect by the reciprocating drive means, and thus, in association with the deflection of the base portion, the plurality of the protrusions provided in the base portion tilt and rise iteratively. As a result, the protrusions move toward and away from one another alternately, and by such movement of the protrusions, the scalp can be massaged in a complicated manner so as to massage, rub and tap the scalp. Particularly, the protrusions are each formed so as to have a narrow distal end and a wide proximal end and besides a convexly curved opposite face, thereby enabling such massaging, etc to be performed as if done by fingertips.

According to the above prior art, however, when washing hair or massaging a scalp, the treating section has been required to be pressed against the scalp with the massaging device being grasped after having applied a lathery shampoo to the hair and scalp either for washing the hair and scalp or for preventing the hair from being damaged due to friction. Hence, some amount of preliminary labor has been required to use the massaging device. Besides, there have been possibilities that when making a lather with the shampoo or the like by hand, it is difficult to make a minute lather with the shampoo by hand, thus resulting in an insufficient washing effect to the hair and scalp as well as a poor protecting effect to the hair against the friction. Further, there have been concerns that when carrying the massaging device by a slippery hand with the shampoo applied thereto, the massaging device might be dropped and damaged and, in the worst case, a user might be injured.

### SUMMARY OF INVENTION

It is, therefore, an object of the present invention to solve the foregoing problems and provide a massaging device enabling hair washing and scalp massaging to be readily, effectively and reliably performed.

According to a first aspect of the present invention, there is provided a massaging device comprising:

a drive section including a frame;

a treating section operated by said drive section, said treating section including:

a base portion made of an elastic material, said base portion being detachably retained by said frame of the drive section with a periphery thereof being held in a fixed position relative to said drive section; and a plurality of projections protruded from said base portion; and

a reciprocating drive means provided in said drive section for deflecting said base portion in a direction intersecting with a surface of said base portion,

wherein a communicating slit is provided in said protrusions or said base portion, said communicating slit allowing an interior of a region surrounded by said drive section and said treating section to communicate with an exterior thereof; and a container communicating with said communicating slit and moving in response to the deflection of said base portion is provided in said region.

According to a second aspect of the present invention, there is provided a massaging device according to the first aspect in which the container is made of an elastic material.

According to a third aspect of the present invention, there is provided a massaging device according to the second aspect in which the elastic material is made of sponge.

According to a fourth aspect of the present invention, there is provided a massaging device according to any one of the first to third aspects in which a substance to be contained in said container is a liquid detergent.

According to the first aspect of the present invention, through the iterative deflection of the base portion of the treating section by the reciprocating drive means, the container provided in the region surrounded by the drive section and the treating section is compressed in association with the deflection of the base portion. As a result, the substance contained in the container is supplied to a scalp or the like via the communicating slit. Accordingly, it is not necessary for a user to first apply the contained substance or shampoo to the hair or the scalp and then use the massaging device, and therefore the contained substance can be supplied readily to the hair and the scalp to perform the hair washing and massaging. Besides, in this case, since the contained substance does not adhere to a user's hand grasping the massaging device, the likelihood of sliding the massaging device out of the user's hand to drop can be reduced.

According to the second aspect of the present invention, the container is compressed and decompressed iteratively in association with the deflection of the base portion and thus the contained substance can be iteratively supplied.

According to the third aspect of the present invention, the contained substance can be contained in the container in a permeated state.

According to the fourth aspect of the present invention, it is not necessary for a user to first apply the liquid detergent foamed by a user to the hair or the scalp and then use the massaging device, and therefore the efforts of foaming the liquid detergent and applying the liquid detergent to the hair and the scalp can be saved to perform hair washing and massaging through the readily supply of the contained substance to the hair and the scalp. Then, when the container is compressed and decompressed iteratively by allowing the base portion to deflect, air is allowed to come in and out of the communicating slits so that the liquid detergent is minutely foamed, so that the liquid detergent thus minutely foamed is supplied to the hair and the scalp via the communicating slit. As a result, not only the hair and the scalp can be effectively washed but also the hair is protected due to the minute lather thus made.

### BRIEF DESCRIPTION OF THE DRAWING

The invention will be more readily understood by reference to the following description, taken with the accompanying drawings, in which:

FIG. 1 is a cross-sectional view illustrating an embodiment of the present invention.

FIG. 2 is a perspective view illustrating the embodiment of the present invention.

FIG. 3 is an exploded perspective view illustrating the embodiment of the present invention.

FIG. 4 is a cross-sectional view illustrating surrounding portions of a base portion in a convexly curved state in the embodiment of the present invention.

FIG. 5 is a cross-sectional view illustrating surrounding portions of a base portion in a concavely curved state in the embodiment of the present invention.

### DESCRIPTION OF THE PREFERRED EMBODIMENT

The following is a detailed description of a preferred embodiment of the present invention with reference to the appended drawings. The embodiment described below is not to limit any scope of the present invention set forth in the claims. Further, the whole of the systems described below is not necessarily the absolutely imperative requirements of the present invention.

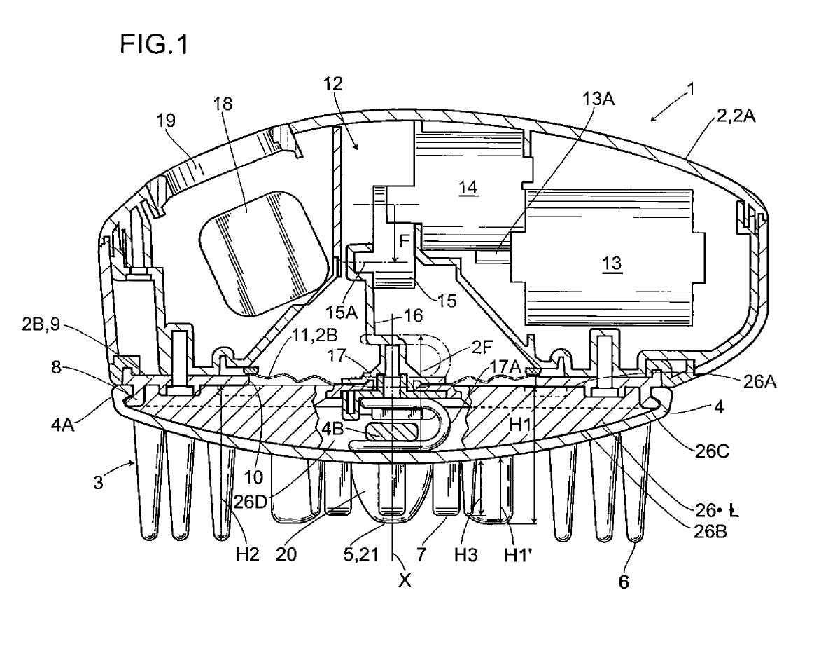

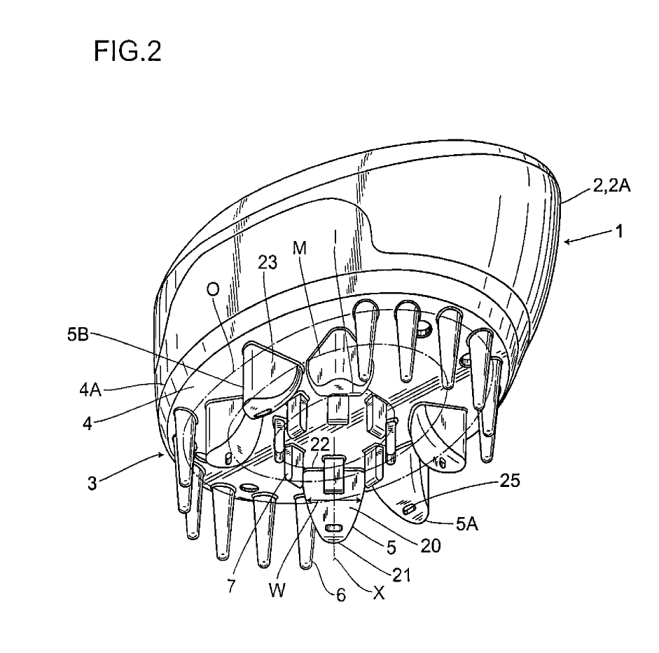

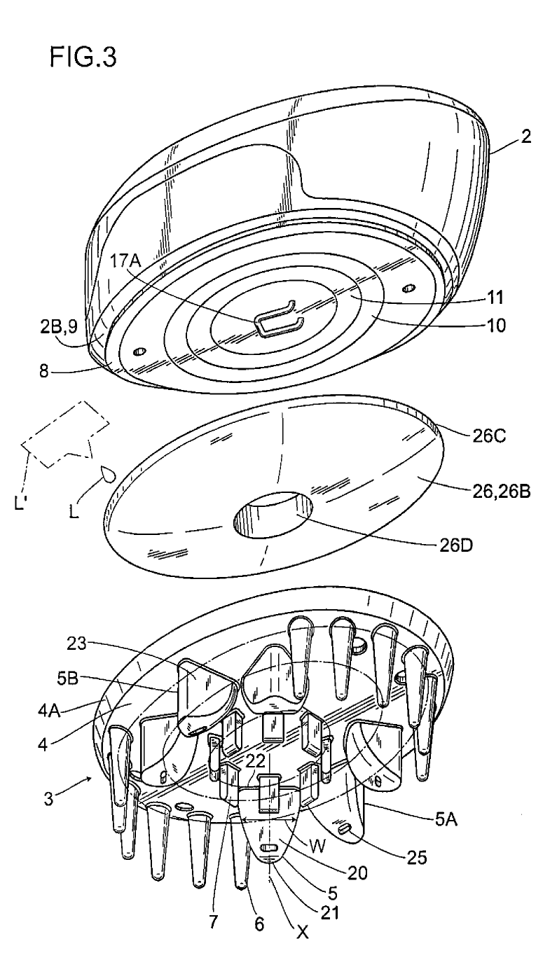

FIGS. 1 to 5 illustrate a first embodiment. In the present embodiment, upper and lower positions are defined on the drawing of FIG. 1. Numeral 1 denotes a massaging device, which includes a massaging device main body 2 acting as a drive section and a treating section 3 detachably held on the downside of this massaging device main body 2. The treating section 3 comprises a base portion 4 and protrusions 5, 6, and 7 which protrude to the downside that is the direction intersecting with a lower surface of the base portion 4 and are provided integrally with the base portion 4. Further, the base portion 4 is elliptical in plain view and is formed from flexible and elastic elastomer. An edge 4A of the base portion 4 is fixed to a lower edge of the massaging device main body 2. In addition, the term “fixed” here is meant to include a state where a connection is made with some slight movement allowed. In the present embodiment, the edge 4A of the base portion 4 is fitted into a frame body 8, used for fixing, including a groove formed along the lower surface of the massaging device main body 2 and thus both the massaging device main body 2 and the base portion 4 are detachably connected over an entire circumference thereof.

The massaging device main body 2 includes a case main body 2A which has an opening at a bottom side and has a size that enables holding by one hand and a bottom 2B which closes the bottom side where the case main body 2A has an opening. The bottom 2B includes a bottom plate 9 and a cover 11. Further, the bottom plate 9 is elliptically formed in plain view and an outer circumferential of the bottom plate 9 is fixed to a bottom edge of the case main body 2A. Besides, a circular window opening 10 is vertically formed through a central portion of the bottom plate 9. The cover 11 covering the window opening 10 is retractable. The cover 11 is provided to water-tightly seal the window opening 10 by a bellows-shaped film made of a flexible material such as rubber, synthetic rubber, elastomer or the like. Furthermore, inside the massaging device 2, there is provided a reciprocating drive means 12 which reciprocates a central portion of the base portion 4 up and down. The reciprocating drive means 12 is equipped with a motor 13 which is provided on the bottom plate 9 and acts as a drive source, a crank mechanism 15 connected to a motor shaft 13A of the motor 13 via a speed reduction gear mechanism 14, and a connecting rod 16 whose one side is connected to an eccentric shaft 15A of the crank mechanism 15 and whose other side is connected to a substantially central portion of an upper surface of the base portion 4. In addition, a connection intermediary member 17 is fitted integrally on a nearly central portion of the cover 11. This connection intermediary member 17 sandwiches the cover 11 by the upper surface side of the member 17 and the other side of the connecting rod 16 to support and fix the cover 11. Besides, in the lower surface side thereof, there is provided a hook 17A, to which a hook receiving portion 4B provided in the upper surface of the central portion of the base portion 4 is detachably connected. Accordingly, rotary movement of the motor 13 is converted into reciprocating movement by the crank mechanism 15 and the connecting rod 16, so that the connection intermediary member 17 reciprocates up and down. As a result at a position where the hook receiving portion 4B is provided, maximum amplitude occurs in the base portion 4 to give an amplitude twice as large as the eccentric distance F (=2F) from a central axis of the crank mechanism 15 to the eccentric shaft 15A. A virtual central axis X is formed vertically through the hook receiving portion 4B and the connection intermediary member 17. Inside the massaging device main body 2, there is provided a battery 18 for supplying electric power to the motor 13, and besides on a surface of an upper side of the massaging device main body 2, there is provided a switch 19 for operating the motor 13.

Next is a detailed description of the treating section 3. The protrusions 6, 7 and 5 are arranged around the virtual central axis X that passes vertically through a substantially middle position of the base portion 4, along an elliptical virtual outer ring O located along the edge 4A of the base portion 4, along a substantially circular virtual inner ring I located inside the ring O, and along a substantially circular virtual middle ring M located between the rings O and I, respectively.

A plurality of the first protrusions 5 spaced from one another along the virtual middle ring M are provided at intervals in a mutually opposite manner with the central axis line X defined as a center. In the present embodiment, the first protrusions 5 are provided so as to form two axisymmetrically-allocated groups each of which comprises three protrusions arranged in a circular-arc, thus resulting in total six protrusions 5 provided. That is, the first protrusions 5A in the group comprising three protrusions allocated at one side are opposed to, with the central axis line X sandwiched, the first protrusions 5B in the group comprising three protrusions allocated at the other side. Further, a distal end 21 of an opposite surface 20 facing the central axis line X in each first protrusion 5 is formed in a tapered shape and on the contrary a proximal end 22 thereof is formed so as to become gradually large in width W as coming close to its proximal end so that they are connected integrally with the base portion 4. As a result, the opposite surface 20 is formed in a substantially triangle shape ranging from the distal end 21 to the proximal end 22. The opposite surface 20 has an outward convexly curved shape so as to make a distance Z of a side of the distal end 21 from the central axis line X longer than that of a side of the proximal end 22. In addition, the maximum width of the opposite surface 20 in the first protrusion 5 is formed of the order of that of a finger and further the maximum height of the opposite surface 20 equals substantially a length from the tip of a finger to the top joint.

Further, the first protrusions 5 are provided in a protruding manner, forming a substantially triangular pyramid provided integrally with lateral sides 23 at both left and right sides of the opposite surface 20. Furthermore, the first protrusions 5 are convexly formed integrally with the base portion 4 to a substantially the same thickness as that of the plate-like base portion 4. Accordingly, a hollow portion 24 is formed inside the first protrusion 5 and then an opening 24A is provided in an upper portion of the hollow portion 24. Through the upper opening 24A, the hollow portion 24 communicates with an upper side of the base portion 4, that is, a space between the base portion 4 and the bottom surface 2B. On the one hand, at a position biased to the distal end 21 of the opposite surface 20 of the first protrusion 5, a long sideways communicating slit 25 is formed in a penetrating manner. Through the communicating slits 25, the hollow portion 24, eventually the space between the bottom surface 2B and an interior surface of the base portion 4 and an exterior portion of the first protrusion 5 communicate with each other.

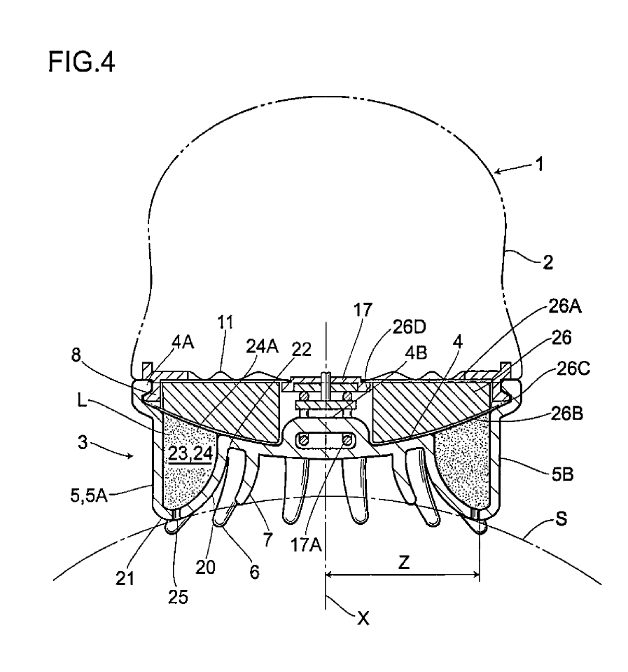

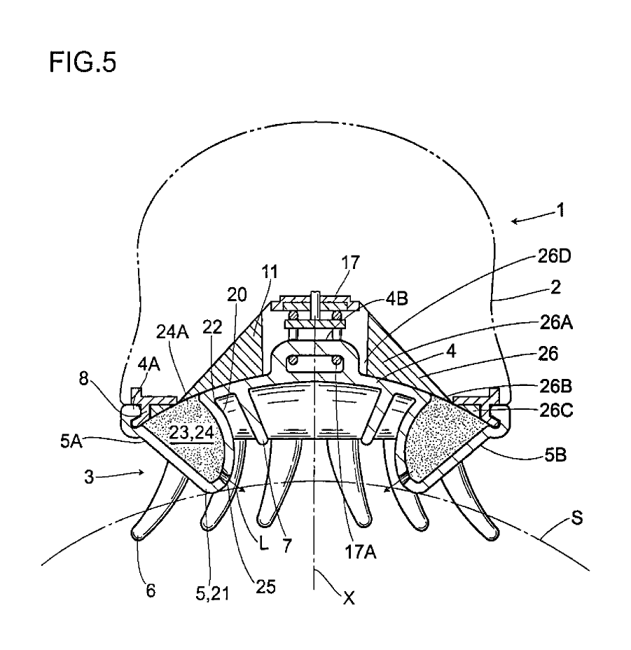

Furthermore, the second protrusions 6 spaced from one another along the virtual outer ring O are formed in a rod-like shape which is somewhat tapered toward its distal end and whose distal end is rounded (i.e., a conical shape whose vertex angle is small). A distance H2 from a side of the bottom plate 9 is formed so as to become always larger than a distance H1 from the bottom plate 9 in the first protrusion 5. That is, even if the first protrusion 5 moves vertically as a result of the deformation of the treating section 3 in the range of the states in FIG. 4 and in FIG. 5, the distal end of the second protrusion 6 is formed so as to be always located at a position lower than the most lower position to which the distal end of the first protrusion 5 comes. A planar dimension per one second protrusion 6 is formed to be smaller than that of one first protrusion 5. In addition, groups comprising a plurality of the second protrusions 6 is each located in both sides of a longitudinal axis direction in the base portion 4 whose plane is elliptical.

Moreover, the third protrusions 7 spaced from one another along the virtual inner ring I each have a square-pole shape whose distal end is rounded. A distance H3 from the base portion 4 is formed to be smaller than a distance H1′ from the base portion 4 in the first protrusion 5. Besides, a planar dimension per one third protrusion 7 is formed to be smaller than that of the first protrusion 5.

Further, there is provided a container 26 for liquid detergent that is a contained substance, e.g., a shampoo L between the bottom surface 2B and the inner surface of the base portion 4. The container 26 is iteratively compressed and decompressed in response to deflection of the base portion 4 to foam the shampoo L and thus to discharge the shampoo foamed outward via the hollow portion 24 and the communicating slit 25. In addition, in the present embodiment, the container 26 is formed from sea sponge (natural sponge) or synthetic sponge which comprises continuous air bubble type foamed polyurethane, rubber foam or the like that are an elastic body. When the base portion 4 is deflected downward to pose a convexly curved feature as shown in FIG. 1, the container 26 comes into a nearly uncompressed state or a slightly compressed state to lie between the bottom surface 2B and the upper surface of the base portion 4. In other words, when the base portion 4 is deflected downward to form the convexly curved state, the upper surface 26A of the container 26 contacts with or comes close to the bottom surface 2B and at the same time the lower surface 26B of the container 26 contacts with or comes close to the upper surface 2B and further the outer circumference 26C of the container 26 contacts with or comes closer to the frame body 8. On the one hand, a through hole 26D is formed along the central portion of the container 26, i.e., along the central axis line X. The through hole 26D is formed in size as large as enabling the hook receiving portion 4B and the hook 17A to be inserted thereinto loosely.

Next is a description of behavior of the structure described above. When massaging and washing a scalp S by rubbing in hair washing or the like, first, a user detaches part of or the whole of the edge 4A of the base portion 4 from the frame body 8 and further if required, the user houses the shampoo L into the container 26 in a state where the hook receiving portion 4B and the hook 17A are detached from each other. This is performed by allowing the shampoo L discharged from a nozzle of the container L′ to be infiltrated into the container 26. In addition, as may be necessary, water for attenuating the shampoo L may be infiltrated into the container 26. Thus, after the shampoo L has been contained in the container 26, the hook receiving portion 4B and the hook 17A are connected to each other and further the edge 4A of the base portion 4 is fitted into the frame body 8 to accomplish assembling as shown in FIG. 1. Then, the user grasps the massaging device main body 2 to press the distal ends of the first and second protrusions 5 and 6 against the scalp S and holds the massaging device main body 2 by hand. Then, when the user turns on a switch 19, electric power is fed from the battery 18 and thus the motor 13 is activated for the motor shaft 13A to start to rotate. Along with the rotation of the motor 13, the crank mechanism 15 connected to the motor shaft 13A via the speed reduction gear mechanism 14 also starts to rotate. Then, by the crank mechanism 15 and the connecting rod 16 connected to the eccentric shaft 15A of the crank mechanism 15, the rotational movement of the motor shaft 13A is converted into the reciprocating movement, so that the connection intermediary member 17 connected to the connecting rod 16 begins to reciprocate up and down. Then, the base portion 4 repeats deformation between the convexly curved state where the base portion 4 deflects downward as shown in FIG. 4 and the concavely curved state where the base portion 4 deflects upward as shown in FIG. 5, in a manner that the maximum amplitude occurs at the hook receiving portion 4B connected to the connection intermediary member 17, namely the center of the base portion 4. Then, the amplitude at a position where the maximum amplitude occurs results in twice the eccentric distance F (=2F) from the central axis of the crank mechanism 15 to the eccentric shaft 15A. Herewith, chiefly, such movement is repeated that the first protrusions 5 tilt inwardly to the central axis line X or thereafter rise, thereby rubbing the scalp S to enable massaging. Further, the third protrusions 7 repeat the movement of contacting and leaving the scalp S by the deflection of the base portion 4, thus permitting a massage to be performed so as to tap the scalp S.

In addition, the second protrusions 6 are formed in the vicinity of an outer circumference of the base portion 4 and besides are formed on either side of the longitudinal axis direction in the elliptical base portion 4. Hence, even if the base portion 4 deflects, the second protrusions 6 slightly sway but hardly move. The second protrusions 6 hardly moving perform hardly massaging. By the second protrusions 6, however, a clearance between the massaging device main body 2 and the scalp S can be maintained, so that the treating section 3 can be prevented from being pressed needlessly strongly to the scalp S. Further, if the treating section 3 were pressed needlessly strongly to the scalp S, by the reaction caused by the tilting and rising of the first protrusions 5 due to the deflection of the base portion 4, the massaging device main body 2, eventually a user's hand grasping the massaging device main body 2 would vibrate largely in the central axis line X direction and on the contrary a head pressed by the treating section 3 would be largely swayed to result in a poor massage by the first protrusions 5. A clearance between the massaging device main body 2 and the scalp S is, however, maintained by means of the second protrusions 6 and thus the treating section 3 is not needlessly strongly pressed to the scalp S, so that the user's hand grasping the massaging device main body 2 and the head strongly pressed by the treating section 3 are not largely swayed, thus allowing the massaging to be favorably performed by the first protrusions 5.

Then, the base portion 4 is deformed from the state shown in FIG. 4 to the state shown in FIG. 5. In other words, the base portion 4 makes the transition of deflection from the convexly curved state to the convexly curved state and thus the first protrusions 5 tilt inward with the first protrusion 5 contacting the scalp S, so that the massaging is performed so as to hold the scalp S by the first protrusions 5. In this case, the opposite surface 20 of the first protrusion 5 opposed to the central axis line X is formed in a substantially triangular shape where the distal end 21 side and proximal end 22 side of the opposite surface 20 are formed in a tapered shape and in a gradually widened shape, respectively. As a result, in the state shown in FIG. 4, a portion biased slightly further to the proximal end 22 than the distal end 21 of the opposite surface 20 softly contacts the scalp S and then as being deformed into the state shown in FIG. 5, the distal end 21 side which becomes gradually narrower comes to contact the scalp S, thus enabling a massaging as if a finger-pressure therapy that performs massaging by using fingertips is applied. Further, in each of the first protrusions 5, its distal end 21 backs away in a convexly curved manner further from the central axis line X than does its proximal end 22 and thus when the first protrusions 5 tilt inward and then rise to contact the scalp S, the opposite surface 20 can massage the scalp S ranging from its proximal end 22 side to its distal end 21 side in a sliding manner. Furthermore, two groups comprising the plurality of the first protrusions 5 spaced are provided so as to oppose to each other with the central axis line X defined as a center. Hence, a massaging operation between the two groups of the first protrusions 5A and 5B which are opposed to each other can be performed. Moreover, inversely, even when the base portion 4 makes the transition from the state shown in FIG. 5 to the state shown in FIG. 4 to be deformed, i.e., the base portion 4 deflects with the transition made from its concavely curved state to its convexly curved state, soft massaging as if practiced by fingertips can be practiced by the first protrusions 5.

Further, when the base portion 4 repeats the deformation between the convexly curved state where the base portion 4 has deflected downward as shown in FIG. 4 and the concavely curved state where the base portion 4 has deflected upward as shown in FIG. 5, a space between the base portion 4 and the bottom plate 9, eventually the bottom surface 2B is compressed and decompressed iteratively. As a result, in conjunction with the deflection of the base portion 4, the container 26 is compressed and is decompressed iteratively. When the container 26 is compressed, the shampoo L contained in the container 26 is extruded through the upper opening 24A to the hollow portion 24 to be discharged from the communicating slit 25 to the scalp S. In addition, when being extruded from the container 26 and being discharged from the communicating slit 25, the shampoo L is mixed with air contained in the container 26 and with air existing the space to be foamed, so that the shampoo L foamed is supplied to the hair (not shown) and the scalp S. To the contrary, when the container 26 is decompressed along with the transition of the base portion 4 to the convexly curved state, the shampoo L remaining in the space without being discharged from the communicating slit 25 to the exterior is sucked into the container 26. Besides, ambient air is sucked into the container 26 from the communicating slit 25 via the upper opening 24A. Then, when the container 26 is compressed again, the shampoo L is foamed again, and then the shampoo thus foamed is discharged to the scalp S from the communicating slit 25 via the upper opening 24A and the hollow portion 24. Thus, in response to the deformation of the base portion 4 repeated between the convexly curved state and the concavely curved state, the container 26 is compressed and decompressed iteratively, so that the shampoo L contained in container 26 is foamed to be supplied to the outside of the treating section 3.

In addition, the shampoo L is foamed by the container 26 such as sponge or the like to thereby be minutely foamed and besides to be minutely foamed also when passing through the communicating slit 25. Besides, the smaller the size of the communicating slit 25, the more minutely the shampoo L is foamed. Then, using the shampoo L thus minutely foamed, the scalp S and the hair (not shown) are washed. When washing the hair (not shown) and massaging the scalp S using the massaging device 1 according to the present application, a user need not first foam the shampoo L by using palms of user's hands but then operates the massaging device 1 for the shampoo L infiltrated into the container 26 to be foamed. Hence, not only the hair washing and the massaging can be readily performed but also a lather of the shampoo L that reduces friction does not adhere to the user's hand grasping the massaging device main body 2 and therefore the massaging device 1 can be reduced in the possibility of sliding from the user's hand to be dropped. Further, the hair washing and the massaging can be performed using the shampoo L foamed more minutely than being foamed by user's palms and therefore not only the hair and the scalp S can be effectively washed but also the hair can be certainly protected from the friction between the hair and the treating section 3 made up from a material having comparatively large frictional coefficient such as elastomer or the like.

As stated above, in the above embodiment, there is provided the massaging device 1 in which the frame body 8 of the massaging device main body 2 and the reciprocating drive means 12 located within the massaging device main body 2 are allowed to detachably hold, with the positional relationship to the massaging device main body 2 being fixed, the treating section 3 comprising a plurality of the protrusions 5 to 7 provided in the flexible base portion 4 so as to intersect with the plane of the flexible base portion 4 and then by allowing the base portion 4 to deflect iteratively by the reciprocating means 12 in the direction of intersecting with the surface of the base portion 4, the scalp S or the like is washed or massaged by each of the protrusions 5 to 7. In each of the first protrusions 5, there is provided the communicating slit 25 which makes the interior and exterior of the region surrounded by the massaging device main body 2 and the treating section 3 to communicate with each other and besides in the regions there is provided the container 26 of the shampoo L acting as the contained substance which communicates with the communicating slit 25 and moves in response to the deflection of the base portion 4. Hence, the massaging device 1 is allowed to operate to discharge the shampoo L infiltrated into the container 26 from the communicating slit 25. As a result, not only the hair washing and the massaging can be readily performed but also the shampoo L does not adhere to a hand of a user grasping the massaging device main body 2, thus permitting the possibility of slipping and dropping the massaging device 1 to be reduced.

Further, as being an elastic body, the container 26 is iteratively deformed to permit the shampoo L to be iteratively supplied.

Furthermore, as the container 26 is made of sponge, the shampoo L is infiltrated into the sponge to be contained, so that the shampoo L is not leaked from the communicating slit 25 in disuse.

Besides, the contained substance is the shampoo L that is the liquid detergent and therefore a user need not apply the shampoo L foamed by the user to his/her hair and scalp S beforehand when using the massaging device 1. As a result, the need of foaming and applying the shampoo L to the hair and the scalp S is eliminated and thus not only it becomes possible that the shampoo L is readily supplied to the hair and the scalp S to enable hair washing and massaging but also the hair and the scalp S can be effectively washed and reliably protected by a minute lather because the shampoo L is minutely foamed and supplied to the hair or scalp S due to the air coming in and out of the communicating slit 25 by iteratively compressing and decompressing the container 26.

In addition, the massaging device according to the present invention is not limited to the embodiment described above and various modifications are possible within the scope of the gist of the present invention. In the above embodiment e.g., the communicating slit which allows its interior and exterior portions to communicate with each other is provided in the protrusions of the treating section. However, the communicating slit which makes its inside and outside portions communicate with each other may be provided in the base portion of the treating section and then there may be provided the container of the contained substance which communicates with the communicating slit and moves in response to the deflection of the base portion. Further, in the above embodiment, after detaching the treating section from the massaging device main body, the shampoo is infiltrated into the container. However, a feed opening of the shampoo may be provided in the treating section and then the shampoo may be infiltrated into the container via the feed opening with the treating section undetached.

What is claimed:

1. A massaging device comprising:
a drive section including a frame;
a treating section operated by said drive section, said treating section including: a base portion made of an flexible material, said base portion being detachably retained by said frame of the drive section with a periphery thereof being held in a fixed position relative to said drive section; and a plurality of projections protruded from said base portion; and
a reciprocating drive means provided in said drive section for deflecting said base portion in a direction intersecting with a surface of said base portion,
wherein a communicating slit is provided in said protrusions or said base portion, said communicating slit allowing an interior of a region surrounded by said drive section and said treating section to communicate with an exterior thereof; and a container communicating with said communicating slit and moving in response to the deflection of said base portion is provided in said region.

2. The massaging device according to claim 1, wherein said container is made of an elastic material.

3. The massaging device according to claim 2, wherein said elastic material is sponge.

4. The massaging device according to claim 1, wherein a liquid detergent is contained in said container.

5. The massaging device according to claim 2, wherein a liquid detergent is contained in said container.

6. The massaging device according to claim 3, wherein a liquid detergent is contained in said container.
